(19) United States
(12) Patent Application Publication
(10) Pub. No.: US 2009/0195840 A1
(43) Pub. Date: Aug. 6, 2009

(54) METHOD OF SHADING CORRECTION IN IMAGE READER AND IMAGE PROCESSING APPARATUS

(76) Inventor: Yuki OISHI, Iwate-ken (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/368,480

(22) Filed: Feb. 10, 2009

Related U.S. Application Data
(63) Continuation of application No. 08/740,521, filed on Oct. 29, 1996, now abandoned.

(30) Foreign Application Priority Data
Oct. 31, 1995 (JP) 7-284161

(51) Int. Cl. H04N 1/04; H04N 1/40

(52) U.S. Cl. 358/461; 358/474

(57) ABSTRACT

The invention includes a brightness reading position control section for reading reference data of a reference plate a plurality of times for different locations by an image reader, a reading data storage section for storing the plurality of brightness reading data on the basis of each charge coupled device element, and a correction value computing section for performing computations on the plurality of brightness reading data in order to compute correction reference data for performing shading correction of an image data derived from an original. The invention makes it possible to prevent variations in the correction reference data that occur due to dust sticking onto or scratches formed in the reference plate.

### BACKGROUND OF THE INVENTION

1. Field of the Invention

The present invention relates to a method of shading correction in an image reader, and an image processing apparatus, and, more particularly, to a method of shading correction in an image reader provided with a plurality of charge coupled device (CCD) elements arranged in a row, and an image processing apparatus.

2. Description of the Related Art

In general, image reading means called image scanners are used in peripheral devices of computers, recording devices, or the like. In such image scanners, light from a light source illuminates an original, the light reflected from the original is read by a plurality of CCD elements arranged in a row, the image data of the original obtained by light reflection is converted into an electrical signal, which is output.

A description will hereunder be given of an image scanner as a typical image reader.

FIG. 4 illustrates the critical portion of a common image scanner 9 serving as an image reader. The image scanner 9 comprises a substantially rectangular case body 20 which has an opening 20a at a top side face opposing an original 18, as shown in FIG. 4. As shown in the same figure, the case body 20 contains light sources 22 therein such that the light sources 22 are disposed at the upper right and left ends of the case body 20 and near the opening 20a of the case body 20. These light sources 22 are provided for illuminating the original 18 through a lens 21. A sensor unit 24 is disposed at about the center of the case body 20, and is provided with CCD elements (not shown) arranged in rows in a direction perpendicular to the plane in FIG. 4 so as to convert image data of the original 18 obtained due to light reflected from the original 18. The number of CCD elements used is determined based on the number of pixels (dots) to be read. If a resolution (number of dots) of 120 dots is required to read the original, 120 of them are used.

The CCD elements of the sensor unit 24 of the image scanner 9 do not all have the same sensitivities, so that when, for example, a white color is read, the output values of some CCD elements may be 50, while the output values of other CCD elements may be 70, as a result of which some dots appear white, while others appear black, even when the same color is read.

In addition, since the light sources 22 are not disposed parallel to the CCD elements of the sensor unit 24, when light reflected from an original 18 is read by the CCD elements, the CCD elements at the central portion of the row are brighter while those at each end are darker in the direction of arrangement of the CCD elements. In other words, the CCD elements at each end in the direction of arrangement of the CCD elements have a low maximum output, while those at the central portion in the direction of arrangement of the CCD elements have a high maximum output. Consequently, even when the same color is read, the output value of the CCD element depends on where it is located in the row, so that the CCD element appears white or black depending on where it is located in the row.

The problem of variations in the output of the scanner also arises from variations in the brightness of the light sources 22, variations in the precision of the lens 21, variations in the positional precision of the original 18 and the CCD element, such as the distance between the original 18 and the CCD element, or the like.

To overcome the problem of variations in the output of the scanner, in general, a white reference plate 25 is provided, as shown in FIG. 6. When reading an image data of the original 18 the image scanner 9, reference data regarding the brightness and color of the reference plate 25 is previously read in order to obtain correction reference data such that the output value of the reference data of the reference plate 25 read on the basis of each CCD element becomes a maximum output value of the CCD element. The obtained correction reference data is used to correct the different output values of the CCD elements, obtained when the same color is read, to the same output value, whereby shading correction is achieved.

However, the above-described conventional method of shading correction has the disadvantage that when the reference plate 25 becomes dirty due to dust particles sticking onto the plate 25, or when the reference plate 25 gets scratched, an error occurs in the correction reference data, leading to the possibility of light and dark streaks being produced in the image of the data output from the image scanner 9.

More specifically, dust particles are generally less brighter than the white reference plate 25. A depression formed in the reference plate 25 causes the output value of the CCD element of the image scanner 9 to shift to a smaller value, while a protuberance formed on the reference plate 25 causes the output value of the CCD element to shift to a larger value.

Thus, there has been a demand for a method of shading correction in which an error in the correction reference data does not occur, when the reference plate 25 becomes dirty or gets scratched.

### SUMMARY OF THE INVENTION

Accordingly, an object of the present invention is to provide a method of shading correction in an image reading device, and an image processor, in which an error in the correction reference data is prevented from occurring, when the reference plate becomes dirty or gets scratched.

Another object of the present invention is to provide a method of shading correction in an image reading device, in which the image reading device reads reference data of the reference plate a plurality of times for different locations, whereby an abnormal value, which occurs when the reference plate becomes dirty, is eliminated from the reference data.

A further object of the present invention is to provide an image reading device which reads reference reading data of the reference plate a plurality of times for different locations in order to obtain a plurality of reference data on the basis of each CCD element, and then performs computations on the plurality of reference reading data, whereby a proper correction reference data can be reliably obtained.

A still further object of the present invention is to provide an image reading device in which computations are performed to obtain a maximum value from a plurality of reading data, and the maximum value is used as the correction reference data, in order to prevent the output value of the image scanner (CCD elements) from shifting to a lower value, when the reference plate becomes dirty or a depression is formed therein.

A still further object of the present invention is to provide an image reading device in which computations are performed to obtain a minimum value from a plurality of reading data, and the minimum value is used as the correction reference data, in order to prevent the output value of the image scanner (CCD elements) from shifting to a higher value, when a protrusion is formed on the reference plate.

A still further object of the present invention is to provide an image reading device in which computations are performed to eliminate the maximum value and the minimum value from a plurality of reading data, and the average value of the remaining reading data is determined and used as the correction reference data, in order to prevent the output value of the image scanner (CCD elements) to shift to a lower value, when the reference plate becomes dirty or a depression is formed therein, and to prevent the output value of the image scanner (CCD elements) from shifting to a higher value, when a protrusion is formed on the reference plate.

A still further object of the present invention is to provide an image reading device in which computations are performed to compare reading data of two CCD elements adjacent to each of a plurality of reading data with each of the plurality of reading data on the basis of the reading data of each CCD element of the image reader in order to determine whether the difference between each of the plurality of reading data being the basis of comparison and the reading data of the two CCD elements adjacent thereto being compared therewith is larger than a predetermined value. When the difference is larger than the predetermined value, each of the plurality of reading data is replaced by the average value of the reading data of the two CCD elements adjacent thereto in order to obtain the average value of the reading data. The obtained average value is used as the correction reference data for preventing the output value of the image scanner (CCD element) from shifting to a lower value, when the reference plate becomes dirty or a depression is formed therein, and for preventing the output value of the image scanner (CCD element) from shifting to a higher value, when a protrusion is formed on the reference plate.

A still further object of the present invention is to provide an image processor comprising a brightness reading position control section for reading reference data of a reference plate a plurality of times for different locations, a reading data storage section which forms a portion of image reading means in order to store a plurality of reference reading data on the basis of each CCD element, and a correction value computing section for computing the correction reference data used to perform shading correction of an image data derived from the original by performing computations on the plurality of reference data to be read. Reading the reference data of the reference plate a plurality of times for different locations makes it possible to ensure removal of an abnormal value from the reference data, when the reference plate becomes dirty, and thus to reliably provide proper correction reference data by performing computations on the plurality of reading data.

A still further object of the present invention is to provide an image processor further comprising a correction processing section which uses the correction reference data to correct the image data of the original read by an image reading device to obtain an image data in which shading correction has been achieved, whereby shading correction can be reliably performed, using the proper correction reference data.

### BRIEF DESCRIPTION OF THE DRAWINGS

FIG. 1 is a plan view of an embodiment of a recording device applied to the present invention.

FIG. 2 is a left side elevational view of the recording device of FIG. 1.

FIG. 3 is a plan view of the carriage unit of the recording device of FIG. 1.

FIG. 4 is a structural plan view illustrating the critical portion of the inside of a common image scanner mounting section.

FIG. 5 is illustrative of where the light sources of the image scanner of FIG. 4 are disposed.

FIG. 6 is illustrative of a reference plate of the recording device.

FIG. 7 is a side elevational perspective view of the recording device of FIG. 1.

FIG. 8 is a block diagram showing the critical structural portion of the control means of the recording device of FIG. 1.

### DESCRIPTION OF THE PREFERRED EMBODIMENTS

A description will now be given of the present invention with reference to the preferred embodiments illustrated in the drawings.

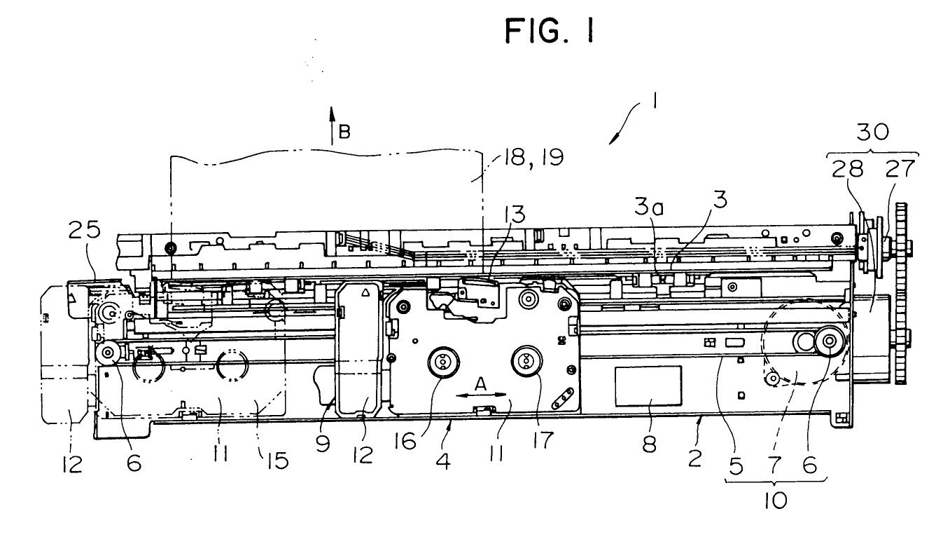

FIGS. 1 to 7 illustrate a method of shading correction in an image reader and an example of a recording device applied to an image processor in accordance with the present invention.

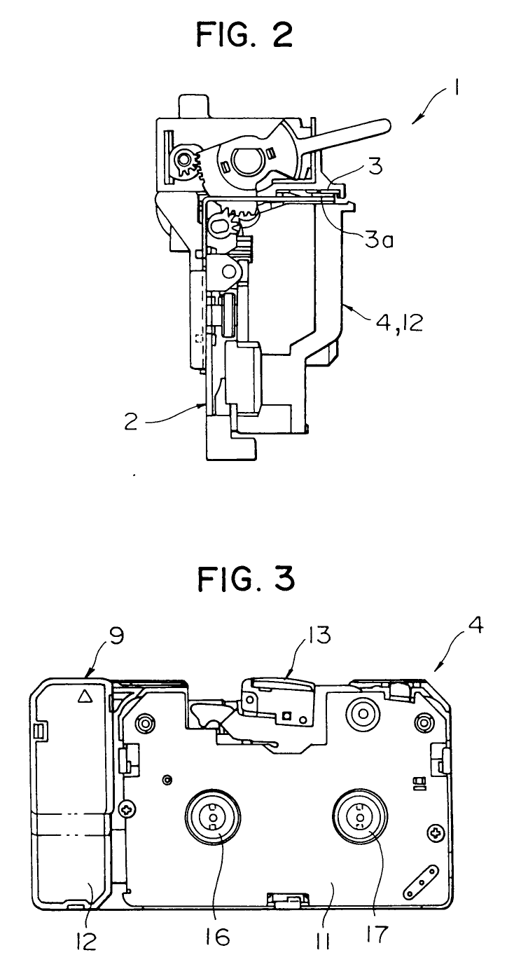

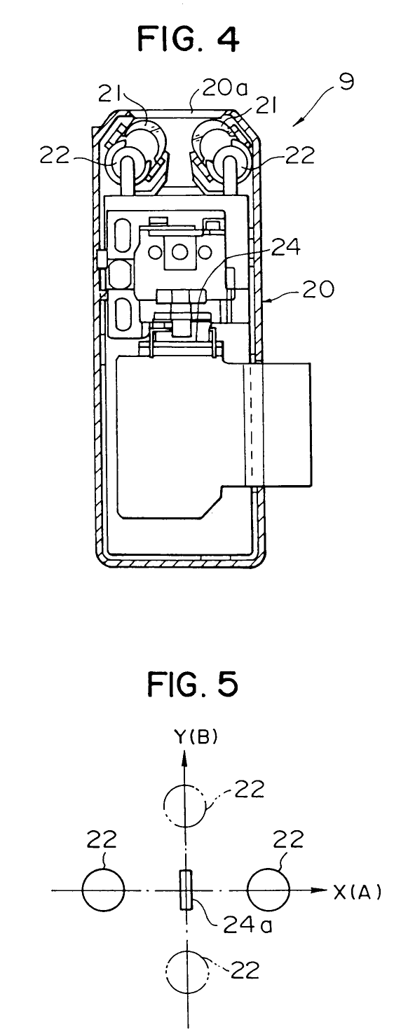

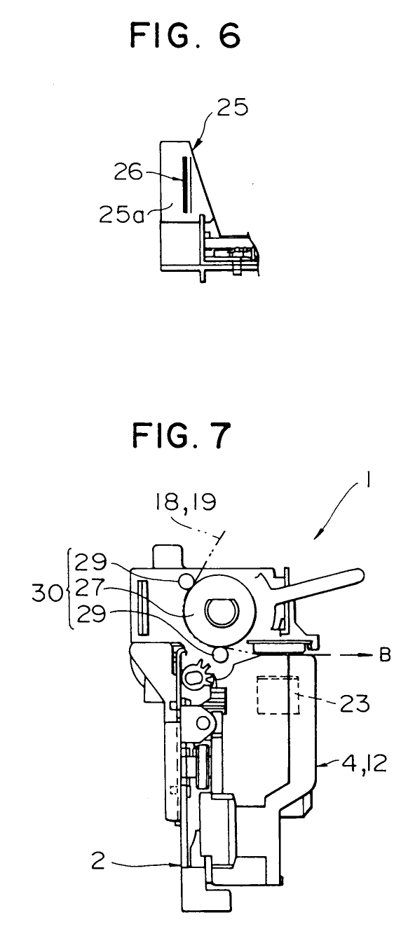

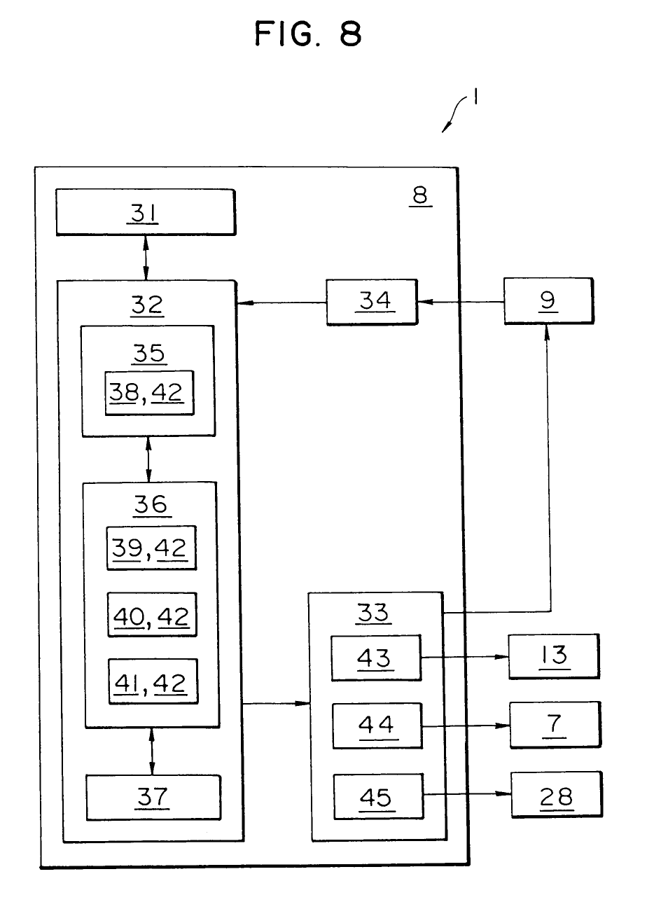

FIG. 1 is a plan view of the critical portion of the recording device. FIG. 2 is a left side elevational view of the recording device. FIG. 3 is a plan view of the carriage unit. FIG. 4 is a structural plan view illustrating the critical portion of the inside of the scanner mounting section. FIG. 5 is illustrative of where the light sources are disposed. FIG. 6 is a front elevational view of the reference plate. FIG. 7 is a side elevational perspective view of the recording device. FIG. 8 is a block diagram showing the construction of the control means.

Referring to FIGS. 1 and 2, the recording device 1 of the present embodiment includes a substantially rectangular frame 2, as viewed in a plane, disposed inside the body thereof (not shown) so as to extend in the left and right directions of FIG. 1, with a recording surface 3a of a flat platen 3 disposed substantially vertically. A carriage unit 4 is disposed forwardly of the platen 3 (or in the lower part of FIG. 1) so as to be reciprocatingly movable along the platen 3.

Referring to FIG. 1, a drive belt 5 is disposed below the carriage unit 4 which is affixed to one location of the drive belt 5. The drive belt 5 is wound around a pair of pulleys 6, 6 disposed near the left and right ends in FIG. 1. In FIG. 1, the right pulley 6 can be rotated by driving power of a carriage motor 7, such as a stepping motor, serving as driving means represented by broken lines. The carriage motor 7 is electrically connected to control means 8 (described later) so as to be driven in response to a control command sent from the control means 8. The control means 8 is disposed at a predetermined location of the frame 2.

More specifically, the carriage motor 7 is driven in response to the control command sent out from the control means 8, causing the carriage unit 4 to move reciprocatingly along the platen 3 in the direction of the double-headed arrow A of FIG. 1.

The above-described belt 5, pulleys 6, 6, and the carriage motor 7 form drive means 10 in order to allow the carriage unit 4 to move reciprocatingly in the main scanning dimension which intersect at right angles to the sub-scanning dimension of the image scanner 9 serving as image reading means. In the present embodiment, the image scanner 9 is a color image scanner.

As shown in FIGS. 1 and 3, the carriage unit 4 comprises a carriage section 11 and a scanner mounting section 12. The carriage 11 forms the right portion thereof, while the scanner mounting section 12 forms the left portion thereof. The carriage section 11 carries a thermal head 13 such that the head 13 opposes the recording surface 3a of the platen 3. The thermal head 13 is provided with a plurality of thermal elements (not shown) arranged in a row in order to be selectively heated based on recording data obtained upon generation of a command signal by the control means 8 to be described later. A head driving mechanism (not shown) allows the head 13 to come into contact and separate from the recording surface 3a of the platen 3 through a sheet 18. Recording is performed where the thermal head 13, in a head-down state, contacts the recording surface 3a of the platen 3.

A ribbon cassette 15, indicated by a phantom line on the left side of FIG. 1, can be mounted onto the upper surface of the carriage section 11. The cassette 15 accommodates a multi-color ribbon (not shown) and guides the multi-color ink ribbon forwardly of the thermal head 13. The carriage section 11 carries a take-up bobbin 16 and a delivery bobbin 17 such that an end of each bobbin projects from the upper surface of the carriage section 11. The take-up bobbin 16 and the delivery bobbin 17 comprise a portion of a conventional ribbon transporting mechanism (not shown) which, when driven, transports the multi-color ink ribbon accommodated in the ribbon cassette 15 mounted on the upper surface of the carriage section 11.

The thermal head 13, the head driving mechanism, and the ribbon transporting mechanism are electrically connected to the control means 8 to be described later, so as to be driven upon generation of a control command from the control means 8.

The thermal head 13 and the head driving mechanism are capable of being driven during direct recording of image data read out from an original 18 onto a sheet 19 such as a post card. The multi-color ink ribbon and the ribbon transporting mechanism can also be driven during recording of image data.

An image scanner 9, serving as image reading means, is disposed on the upper surface of the scanner mounting section 12. As shown in FIG. 4, the scanner 9 comprises a substantially rectangular case body 20 with an opening 20a on the surface thereof facing the platen 3. The case body 20 contains therein two light sources 22 which are disposed near the opening 20a (at the upper left and right ends of the scanner 9) so as to be arranged in a row in opposition to each other and in the main scanning direction of the image scanner 9, the main scanning direction being the direction of movement of the carriage unit 4. Through a lens 21, the two light sources illuminate the original 18, such as a photograph or a postcard, retained at a location in front of the platen 3, whereby an image is read in. A sensor unit 24 is disposed at about the center of the case body 20. The unit 24 is provided with charge coupled device (CCD) elements (not shown) arranged in the vertical dimension in the plane of FIG. 4 in order to convert the image data of the original 18 obtained due to light reflected from the original 18 into an electrical signal, and output the resulting electrical signal to the control means 8. The CCD elements are provided on the bases of the number of pixels (dots) to be read, so that when, for example, a resolution of 120 dots is required in order to read the original 18, 120 CCD elements are provided. The image scanner 9 is electrically connected to the control means 8 to be described later.

More specifically, in the image scanner 9 of the present embodiment, as illustrated by the solid circles in FIG. 5, the two light sources 22 are disposed on an x-axis and symmetrically with an intersection of the x- and a y-axis, with the intersection serving as center. Here, the main scanning dimension of the image scanner 9 defines the x-axis, the sub-scanning dimension being perpendicular to the main-scanning dimension defines the y-axis, and the intersection of the x-and y-axis defines the location of a reading section 24a of the sensor unit 24.

The two light sources 22 may also be disposed on the y-axis and symmetrically with the intersection of the x-and y-axis, as illustrated by the dashed circles in FIG. 5. In addition, a total of four light sources 22 may be provided at the locations indicated by the solid circles and the dashed circles of FIG. 5 in order to illuminate the surface of the original 18 from a greater number of directions. Further, the light sources 22 may be disposed at locations other than on the x-axis or y-axis. In other words, any number of light sources 22 may be disposed at any location based on a design concept, as long as a plurality of light sources 22 are disposed with respect to an intersection serving as center.

Driving power of the scanner motor 7 causes the scanner mounting section 12 to move reciprocatingly along the platen 3 with the carriage section 11, when an image is being read in. In FIG. 1, the direction of movement of the carriage unit 4 indicated by the double-headed arrow A is defined as the main scanning dimension of the image scanner 9.

As shown in FIG. 1, the image scanner 9 is capable of obtaining reference data (white balance) during reading of image data of the original 18 by means of a reference plate 25 which is disposed upright on the left upper surface of the frame 2 and on a line extending from the platen 3. As shown in FIG. 6, the reference plate 25 has a substantially rectangular front face, and a face 25a opposing the image scanner 9 colored white in order to obtain reference data during reading of the original 18. The white color is used due to its brightness. A positioning mark 26 is provided on the opposing face 25a of the reference plate 25 in order to detect the reference position for the operation of the carriage unit 4 with high precision by means of the image scanner 9.

As shown in FIG. 7, a sheet feed roller 27 is disposed below the platen 3 so as to transport at a predetermined speed the original 18 during reading of image data of the original 18 or the sheet 19 during recording in the direction of arrow B of FIG. 7, so as allow the original 18 or the sheet 19 to pass forwardly of the recording face 3a of the platen 3. As shown in FIG. 1, the sheet feed roller 27 can be rotated by driving power of a sheet feed motor 28, such as a stepping motor, disposed at the outer right side of the frame 2.

As shown in FIG. 7, auxiliary rollers 29 are rotatably provided diagonally to the left side and the right side of the sheet feed roller 27, and contact the sheet feed roller with a required contacting force. The rollers 29 rotate in accordance with the rotation of the sheet feed roller 27. In other words, the original 18 or the sheet 19 can be transported by nipping either the original 18 or the sheet 19 between the sheet feed roller 27 and the auxiliary rollers 29. A guide (not shown) is provided at a suitable location around the sheet feed roller 27 in order to guide the original 18 or the sheet 19 along a predetermined transporting path.

The aforementioned sheet feed motor 28 is electrically connected to the control means 9 disposed at a predetermined location on the frame 2, so as to be driven in response to a control command generated from the control means 8.

More specifically, when the sheet feed motor 28 is driven in response to a control command sent from the control means 8, the original 18 or the sheet 9 is transported, as indicated by the arrow B of FIGS. 1 and 7, in a direction perpendicular to the direction of movement of the carriage unit 4 which is indicated by the double-headed arrow A of FIG. 1. The transporting direction of the original 18 or the sheet 19 indicated by the arrow B in FIGS. 1 and 6 is defined as the sub-scanning direction of the image scanner 9.

The sheet feed roller 27, the sheet feed motor 28, and the auxiliary rollers 29 form transporting means 30 in order to transport the original 18 or the sheet 19 in the sub-scanning direction.

Referring back to FIG. 1, the controller 8 is disposed on a predetermined location of the frame 2 in order to control the operation of each section of the recording device 1. As illustrated in FIG. 7, the control means 8 includes at least a CPU 31, a memory 32 such as ROM or RAM with a proper capacity, and a controller 33 for driving each section of the recording device 1.

The memory 32 includes an input data storage section 35, a program storage section 36, and an output data storage section. The input data storage section 35 stores various input data including at least image data and reference reading data of the reference plate 25. The image data is data output from the image scanner 9 and converted into electrical signals in digital form by an A/D converter 34. The program storage section 36 stores various programs. The output data storage section 37 stores various output data such as recording data, control instructions for inputting image data, and control instructions for recording data. The input data storage section 35 includes a reading data storage section 38 for storing on the basis of each CCD element reference reading data of the reference plate 25 output from each CCD element of the sensor unit 24.

The program storage section 36 comprises a correction value computing section 39, a brightness reading position control section 40, and a correcting section 41. The correction value computing section 39 stores a program used to determine the correction reference data, wherein computations are performed on the reference data of the reference plate 25 read on the basis of each CCD element of the sensor unit 24 in order to perform shading correction of the image data derived from the original 18 on the basis of each CCD element. The brightness reading position control section 40 stores a program used for sending only reference data of a plurality of predetermined locations, excluding the portion containing the position mark 26, along the main scanning dimension of the reference plate 25, when the image scanner 9 scans the opposing face 25a of the reference plate 25, based on the input data (all the data that has been scanned) that has been scanned by and output from the image scanner 9. The correcting section 41 stores a program for correcting image data read by the image scanner 9 into image data in which shading corrections have been made, using the aforementioned correction reference data. The program storing section 36 also stores other programs. They include: (a) a program used to form three types of color image data contained in the image data, namely the yellow (Y) image data, the cyan (C) image data, and the magenta (M) image data by separating the these three color image data contained in the image data, (b) a program for forming recording data for each color in order to record data based on each color image data, (c) a program for detecting whether or not the original 18 or the sheet 19 is present, or for detecting the position of the front edge of the original 18 or the sheet 19 being transported in the sub-scanning dimension, based on the input data (all the data that has been scanned) output from the image scanner 9, (d) a program used for detecting the position of both side edges, disposed in the main scanning dimension, of the original 18 or the sheet 19, based on the input data output from the image scanner 9, (e) a program used for detecting the reference position of the carriage unit 4 based on data (that is, the difference in color brightness) detected during passage of the image scanner 9 past the position mark 26, as the scanner 9 scans the face, opposing the image scanner 9, of the reference plate 25 on the basis of the input data output from the image scanner 9, (f) a program for outputting each color recording data in a predetermined order by lines to the output data storage section 37, and (g) a program for controlling the operation of each section, during direct recording of the image data, read from the original 18, directly onto the sheet 19, such as a postcard. When recording, each of the color recording data formed on the basis of the recording program are all output to the output data storage section 37. Based on the program stored in the recording data forming section 39 of the program storage section 36, a central processing unit (CPU) 31 forms color recording data for each color, which are stored in the output data storage section 37.

The above-described reading data storage section 38, the correction value computing section 39, the brightness reading position control section 40, and the correcting section 41 form an image processor 42 of the present embodiment.

Programs to be stored in the correction value computing section 39 for computing the correction reference data include:
1) a program in which the maximum value of the plurality of reading data values stored on the basis of each CCD element is used as the correction reference data.
2) a program in which the minimum value of the plurality of reading data values stored on the basis of each CCD element is used as the correction reference data.
3) a program in which the average value of the plurality of reading data, excluding the maximum and minimum values, stored on the basis of each CCD element is used as the correction reference data.
4) a program in when reading data of two CCD elements adjacent to each of a plurality of data stored on the basis of each CCD element are compared with each of the plurality of data, and the difference in value between the reading data of each of the plurality of data being the basis of comparison and the reading data of the two CCD elements adjacent thereto being compared therewith is larger than a predetermined value, the reading data is replaced by the average value of the reading data of the two adjacent CCD elements in order to determine the average value of the reading data, which is used as the correction reference data.

The program to be stored in the correction value computing section 39 of the control means 8 of the recording device 1 can be selected from the above-described programs, based on the design concept of the recording device 1 and when necessary.

Although in the foregoing description, the image processor 42 has been described as being disposed in the control means 8 of the recording device 1, the image processor 42 may also be disposed in the image scanner 9.

The above-described controller 33 includes at least a head driver 43, a carriage motor driver 44, and a sheet feed motor driver 45. The head driver 43, which applies power to the thermal elements (not shown) of the thermal head 13, is used for driving the thermal head 13. The carriage motor driver 44 is used to drive the carriage motor 7 forming a portion of driving means 10. The sheet feed motor driver 45 is used to drive the sheet feed motor 28 forming a portion of the transporting means 30. The controller 33 further includes other drivers such as a driver (not shown) for moving the thermal head 13 into contact and away from the platen 3, and a ribbon driver for driving an ink ribbon transporting mechanism (not shown).

Using the various programs stored in the program storage section 36 and based on the input data output from the image scanner 9, the CPU 31 detects whether or not the original 18 or the sheet 19 is present, the position of the front edge of the original 18 or the sheet 19, the position of a side edge of the original 18 or the sheet 19, and the reference position of the carriage unit 4. The detected data is stored in the output data storage section 37.

The construction of the control means 8 is not restricted to the construction of the present embodiment. It may be such that the sections are divided into a plurality of independent sections.

The recording device 1 of the present invention is constructed such that various external signals can be input to the control means 8, and the input can be controlled, thereby allowing the recording device to be utilized also as a common printer for recording an image, formed by a word processor or computer, onto the sheet 19.

A description will now be given of the operation of the recording device with the above-described construction.

Reading of the image data of the original 18 by the recording device 1 of the present embodiment is started by having someone set the front edge of the original 18 between the sheet feed roller 27 and one of the auxiliary rollers 29 (disposed diagonally to the lower left of the sheet feed roller 27 in FIG. 7) such that the original 18 is nipped therebetween. When the original 18 is set, the control means 8 sends out, on the basis of a program previously stored in the memory 32, a control command to the image scanner 9, the carriage motor 7, and the sheet feed motor 28, whereby the light sources 22 of the image scanner 9 are turned on, causing them to be in operation, the carriage unit 4 starts to move along the platen 3 in the main scanning dimension of the image scanner 9 to reach the home position HP at the left part of FIG. 1, and the original 18 starts to be transported in the sub-scanning dimension of the image scanner 9. When the carriage unit 4 is already at the home position HP, the carriage unit 4 is temporarily transported to the right and then moved back to the home position HP. The light sources 22 of the image scanner are turned on and made operable, not only during recording of an image, but also during recording of an image.

While the image scanner 9 moves in the main scanning dimension toward the home position HP, the image scanner 9 reads all the data located forwardly of the image scanner 9, and the front edge of the original 18 is located to start reading of the image data of the original 18.

The A/D converter 34 converts the input data (or all of the data that has been scanned) which has been read by the image scanner 9 into an electrical signal in digital form, which is stored in the input data storage section 35 of the memory 32, as illustrated in FIG. 8.

Based on the programs stored in the program storage section 36, and the input data, the CPU 31 detects whether or not the original 18 is present, the position of the front edge of the original 18, the position of a side edge of the original 18, and the reference position of the carriage unit 4, with the reference reading color (white balance) established by the opposing face 25a of the reference plate 25.

A description will be given in detail of the establishment of the reference data (white balance) by means of the opposing face 25a of the reference plate 25.

As illustrated in FIG. 8, the A/D converter 34 converts the input data (or all of the data that has been scanned) read by the image scanner 9 into an electrical signal in digital form, which is stored in the input data storage section 35 of the memory 32. The reading data storage section 38 stores reading data on the basis of each CCD element of the sensor unit 24, based on these input data and the program stored in the brightness reading position control section 40 of the program storage section 36. The reading data corresponds to the reference data of the plurality of predetermined locations of the reference plate 25 in the main scanning direction, excluding the portion containing the position mark 26. The reference data is obtained when the image scanner 9 scans the opposing face 25a of the reference plate 25. More specifically, it is possible to read reference data of a plurality of locations of the opposing face 25a, excluding the location including the position mark 26, of the reference plate 25 according to each CCD element of the sensor unit 24, so as to store the plurality of brightness reference reading data into the reading data storage section 38 on the basis of each CCD element.

The plurality of brightness reference reading data stored in the reading data storage section 38 on the basis of each CCD element are subjected to computation based on the program stored in the correction value computing section 39, whereby a proper correction reference data is reliably computed in order to correct variations in the sensitivity of the CCD elements, as a result of which the shading correction of image data derived from the original is performed.

When emphasis is placed on preventing shifting of the output value of the image scanner 9 to a lower value resulting from dust sticking onto the reference plate 25 or a depression formed in the reference plate 25, the maximum value of the plurality of reading data stored on the basis of each CCD element is used as the correction reference data.

When emphasis is placed on preventing shifting of the output value of the image scanner 9 to a higher value resulting from a protrusion formed on the reference plate 25, the minimum value of the plurality of reading data stored on the basis of each CCD element is used as the correction reference data.

When emphasis is placed on preventing both the shifting of the output value of the image scanner to a higher value and to a lower value, two different kinds of correction reference data can be used. One kind of correction reference data is the average value of the plurality of reading data, excluding the maximum value and the minimum value, stored on the basis of each CCD element. The other kind of correction reference data is the average value obtained by comparing reading data of two CCD elements adjacent to each of a plurality of reading data stored on the basis of each CCD element with the each of the plurality of reading data. When the difference between each of the plurality of reading data being the basis of comparison and the reading data of the two CCD elements adjacent thereto being compared therewith is larger than a predetermined value, each of the plurality of reading data are replaced by the average value of the reading data of the two adjacent CCD elements in order to determine the average value of the reading data.

The image scanner 9 detects whether or not the original 18 is present, the position of the front end thereof, the position of a side edge thereof, and the reference position of the carriage unit 4. Based on the detection results, the control means 8 sends out control commands to the carriage motor 7 and the sheet feed motor 28, as a result of which the carriage unit 4 is reliably positioned at the home position HP, and the front end of the original 18 is accurately and reliably located.

The reference position of the carriage unit 4 can be detected based on data obtained when the color image scanner 9 moves past the position mark 26 of the opposing face 25a of the reference plate 25, thus making it possible to increase the precision of detection compared to the case where the opposing face 25a of the reference plate 25 is used, and to reliably position the carriage unit 4 at the home position HP with high precision.

When reading of the image data of the original 18 is commenced, the control command generated from the control means 8 causes the carriage motor 7 to be driven, causing the carriage unit 4 to move toward the right in FIG. 1 in order for the color image scanner 9 to read one line of image data of the original 18 on the basis of each CCD element of the sensor unit 25. Upon completion of the reading of one line of image data of the original 18, the control command of the control means 8 causes the sheet feed motor 28 to be driven, causing the original 18 to be transported by one line in the subscanning dimension which intersects at right angles to the main scanning dimension of the image scanner 9.

All of the image data of the original 18 is read one line at a time, and as shown in FIG. 8, the A/D converter 34 converts the read image data into an electrical signal in digital form in order to successively store the digital data into the input data storage section 35 of the memory 32, as a result of repeated movement of the image scanner 9 one line at a time in the main scanning dimension, and repeated transportation of the original 18 one line at a time in the subscanning dimension which intersects at right angles to the main scanning dimension of the image scanner 9.

The image data of the original read by lines by the color image scanner 9 is subjected to shading correction based on the correction reference data computed for each CCD element of the sensor unit 24 using the program stored in the correcting section 41, after which various data processing operations are performed to successively store the data as recording data into the output data storage section.

To sum up the processing of image data of the original 18 by the recording device 1 of the present embodiment, the reference data of the reference plate 25 is read a plurality of times for different locations on the basis of each CCD element of the image scanner 9 in order to obtain a plurality of reference reading data of the reference plate 25. Then, computations are performed on the plurality of reference reading data of the reference plate 25 on the basis of each CCD element in order to eliminate an abnormal value of the reference data of the reference plate 25, as a result of which a proper correction reference data is obtained. This correction reference data is used to perform shading correction of the image data derived from the original 18 read by the image scanner. Thereafter, various editing operations are performed to obtain the desired output, thereby completing the data processing.

The present invention makes it possible to solve the above-described conventional problems. More specifically, the present invention makes it possible to reliably prevent variations that occur in the correction reference data as a result of dirt sticking onto or scratches formed in the reference plate 25, and thus to reliably and properly perform shading correction of an image data derived from the original 18 read by the image scanner 9.

The present invention is not limited to the above-described embodiment, so that various modifications may be made, when necessary.

As can be understood from the foregoing description, according to the method of shading correction in an image reading means and the image processor of the present invention, reference data of the reference plate is read a plurality of times for different locations in order to reliably eliminate the effects produced by dust sticking onto or scratches formed in the reference plate, whereby a proper correction reference data is reliably obtained for performing shading correction of the image data.

What is claimed is:

1. A method of shading correction in an image reading means by reading reference data of a reference plate in order to correct variations in sensitivities of the image reading means provided with a plurality of charge-coupled device elements arranged in a row, said method comprising reading reference data a plurality of times such that different locations of the reference plate are read by the image reading means.

2. A method of shading correction in an image reading means by reading reference data of a reference plate in order to correct variations in sensitivities of the image reading means provided with a plurality of charge-coupled device elements arranged in a row, said method comprising the steps of:
reading the reference data of the reference plate a plurality of times such that different locations of the reference plate are read in order to obtain a plurality of reference reading data on the basis of each charge-coupled device element; and
performing computations on the plurality of reference reading data in order to obtain correction reference data for performing shading correction of an image data derived from an original.

3. A method of shading correction in an image reading means according to claim 2, wherein said computation step comprises determining the maximum value from the plurality of reference reading data.

4. A method of shading correction in an image reading means according to claim 2, wherein said computation step comprises determining the minimum value from the plurality of reference reading data.

5. A method of shading correction in an image reading means according to claim 2, wherein said computation step comprises eliminating the maximum and minimum values from the plurality of reference reading data, and determining the average value of the remaining reading data.

6. A method of shading correction in an image reading means according to claim 2, wherein said computation step comprises:
comparing each of the plurality of reference reading data with reference reading data of two charge-coupled device elements adjacent to each of the plurality of reference reading data on the basis of the reference reading data of each charge-coupled device element of the image reading means; and
when the difference between the reading data of each of the plurality of reading data being the basis of comparison and the reading data of the two adjacent charge-coupled device elements being compared therewith is greater than a predetermined value, replacing the plurality of reading data with an average value of the reading data of the two charge-coupled device elements adjacent thereto in order to determine an average value of the reading data.

7. A image processor in which shading correction is performed of image data derived from an original read by an image reading means provided with a plurality of charge-coupled device elements arranged in a row, said processor comprising:
a brightness reading position control section for reading reference data of a reference plate a plurality of times such that difference locations of the reference plate are read;
a reading data storage section for storing the plurality of reference reading data on the basis of each charge-coupled device element; and
a correction value computing section for computing correction reference data by performing computations on the plurality of reference reading data in order to perform shading correction of the image data derived from the original.

8. An image processor according to claim 1, further comprising a correcting section for performing shading correction of the image data derived from the original read by the image reading means, using the correction reference data.
